(19) United States
(12) Patent Application Publication
(10) Pub. No.: US 2010/0105285 A1
(43) Pub. Date: Apr. 29, 2010

(54) MICRO-CURRENT MASSAGING BRASSIERE PAD

(76) Inventor: Hung-Chiang Shao, Banciao City (TW)

Correspondence Address: PAI PATENT & TRADEMARK LAW FIRM, 1001 FOURTH AVENUE, SUITE 3200, SEATTLE, WA, 98154, US

(21) Appl. No.: 12/477,125

(22) Filed: Jun. 2, 2009

(30) Foreign Application Priority Data
Oct. 29, 2008 (TW) 097219302

(51) Int. Cl. A41C 3/10; A61H 7/00

(52) U.S. Cl. 450/56; 450/57; 601/84

(57) ABSTRACT

A micro-current massaging brassiere pad includes a flexible pad, a controller mounted in the pad and having a control IC for outputting a pulse waveform and two lead wires for connection to the positive pole and the negative pole of a power source respectively, an electrically insulative outer cover layer covered on the outer side of the pad, and an inner cover layer covered on the inner side of the pad for direct contact with one breast of a female user, the inner cover layer having two isolated conducting zones respectively connected to the two lead wires of the controller such that when electricity is connected through the lead wires of the controller, a medium or low frequency pulse is discharged through the inner cover layer to stimulate the breast of the female user.

### BACKGROUND OF THE INVENTION

(a) Field of the Invention

The present invention relates to brassiere pads and more particularly to a micro-current massaging brassiere pad, which discharges a medium or low frequency pulse to stimulate a breast of a female user.

(b) Description of the Prior Art

A known medium or low frequency pulse treatment device (massager or therapy apparatus) comprises a controller, and silicon rubber electrodes, silicon rubber gel (conducting gel) or conducting silicon rubber cups attached or applied to the breasts of a female user. When electrically connected, a medium or low frequency pulse is discharged to stimulate the breasts of the female user. A medium or low frequency pulse treatment device of this design is expensive to manufacture. Further, there are limitations on time and place for the application of this design of medium or low frequency pulse treatment device. When a silicon rubber gel (conducting gel) is used, it must be applied to the selected area of the body. A user may feel uncomfortable when a particular part of the body is covered with the silicon rubber gel (conducting gel). Further, it is not easy to clean the silicon rubber gel (conducting gel) after each application. Further, when silicon rubber electrodes or conducting silicon rubber cups are used and attached to the breasts, these heavy members will cause the user to feel uncomfortable. Further, when the silicon rubber electrodes or conducting silicon rubber cups are set in the cups of the user's brassiere and attached to the breasts, the brassiere will be deformed to protrude too far.

### SUMMARY OF THE INVENTION

The present invention has been accomplished under the circumstances in view. A micro-current massaging brassiere pad in accordance with the present invention includes a pad having a controller embedded therein, an electrically insulative outer cover layer covered on the outer side of the pad, and an electrically conductive inner cover layer covered on the inner side of the pad. When the controller is started up, a medium or low frequency pulse is discharged through the electrically conductive inner cover layer to stimulate the female user's breast. This design of micro-current massaging brassiere pad is configured to brassieres of different shapes and sizes.

Further, the electrically conductive inner cover layer can be made to have two conducting zones isolated by an electrically insulative portion and respectively connected to positive and negative lead wires of the controller.

Further, a switch may be connected to the positive and negative lead wires of the controller and set for operation by the user to control the operation of the controller. Further, the switch can be made in the form of a necklace.

### BRIEF DESCRIPTION OF THE DRAWINGS

FIG. 1 is an exploded view of a micro-current massaging brassiere pad in accordance with the present invention.

FIG. 2 is a sectional assembly view of the micro-current massaging brassiere pad in accordance with the present invention.

FIG. 3 is a schematic sectional view of the present invention, showing the micro-current massaging brassiere pad mounted in a brassiere and kept in contact with the skin of the user's breast.

FIG. 4 illustrates two micro-current massaging brassiere pads connected in a set.

FIG. 5 corresponds to FIG. 4, showing a switch connected to the lead wires of the controller.

FIG. 6 illustrates an installation example of the set of micro-current massaging brassiere pads of FIG. 4 in a brassiere worn on a woman.

FIG. 7 illustrates another installation example of the set of micro-current massaging brassiere pads of FIG. 4 in a brassiere worn on a woman.

FIG. 8 illustrates an installation example of the set of micro-current massaging brassiere pads of FIG. 5 in a brassiere worn on a woman.

FIG. 9 illustrates another installation example of the set of micro-current massaging brassiere pads of FIG. 5 in a brassiere worn on a woman.

FIG. 10 is a schematic drawing of the present invention, showing the outer cover layer of the micro-current massaging brassiere pad provided with a zip fastener.

FIG. 11 is a schematic drawing of the present invention, showing the micro-current massaging brassiere pad provided with a through hole for nipple.

FIG. 12 is an exploded view of an alternate form of the micro-current massaging brassiere pad in accordance with the present invention.

FIG. 13 is a perspective view of two micro-current massaging brassiere pads configured according to the design of FIG. 12.

FIG. 14 is a schematic drawing, showing the two micro-current massaging brassiere pads of FIG. 13 mounted in a brassiere worn by a woman.

### DETAILED DESCRIPTION OF THE PREFERRED EMBODIMENTS

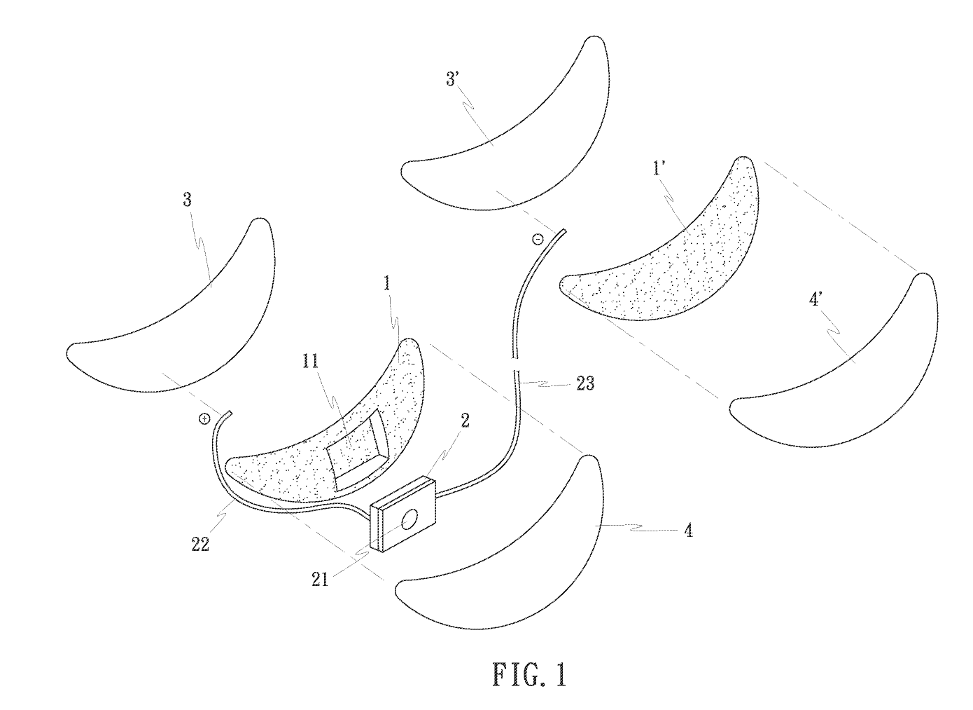

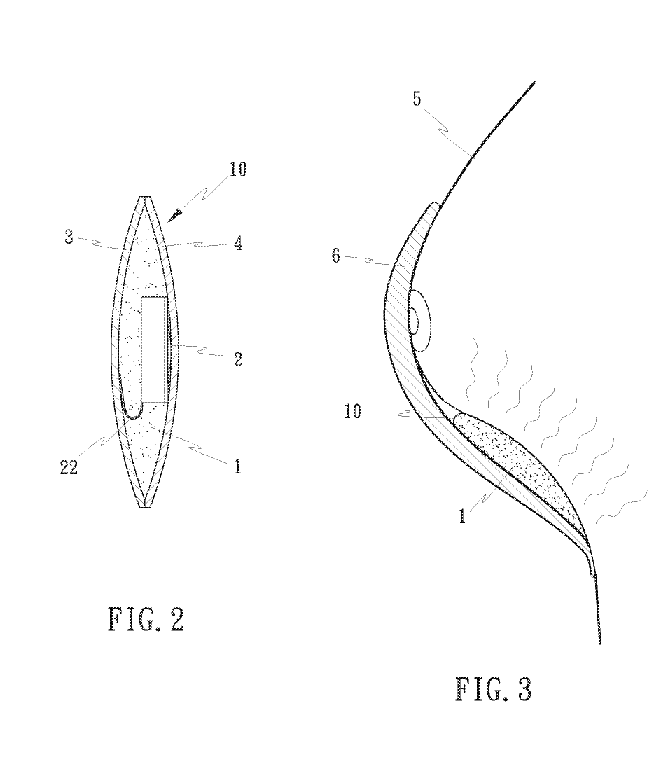

Referring to FIGS. 1 and 2, a micro-current massaging brassiere pad 10 is shown comprising a pad 1, a controller 2, an inner cover layer 3 and an outer cover layer 4.

The pad 1 is a flexible member made of sponge or silicon rubber, having a recessed hole 11 for accommodating the controller 2.

The controller 2 has installed therein a control IC that provides a pulse waveform to charge and discharge an inductance and a capacitor, thereby producing a high pressure. By means of the operation of a program to control the pulse width (about 1 Hz˜150 Hz), a medium or low frequency massaging effect is produced. The controller 2 has a control button 21 for the controls of current up, current down, time setting, power on, power off, and massage mode selection. The controller 2 further has two lead wires 22 and 23 respectively connected to the positive pole and the negative pole of power source.

The inner cover layer 3 is made of an electrically conductive material (for example, conducting cloth or conducting yarns), and covered on the inner side of the pad 1 for direct contact with the skin of a female breast 4 (see FIG. 3).

The outer cover layer 4 is made of an electrically insulative material, and covered on the outer side of the pad 1 to shield the controller 2.

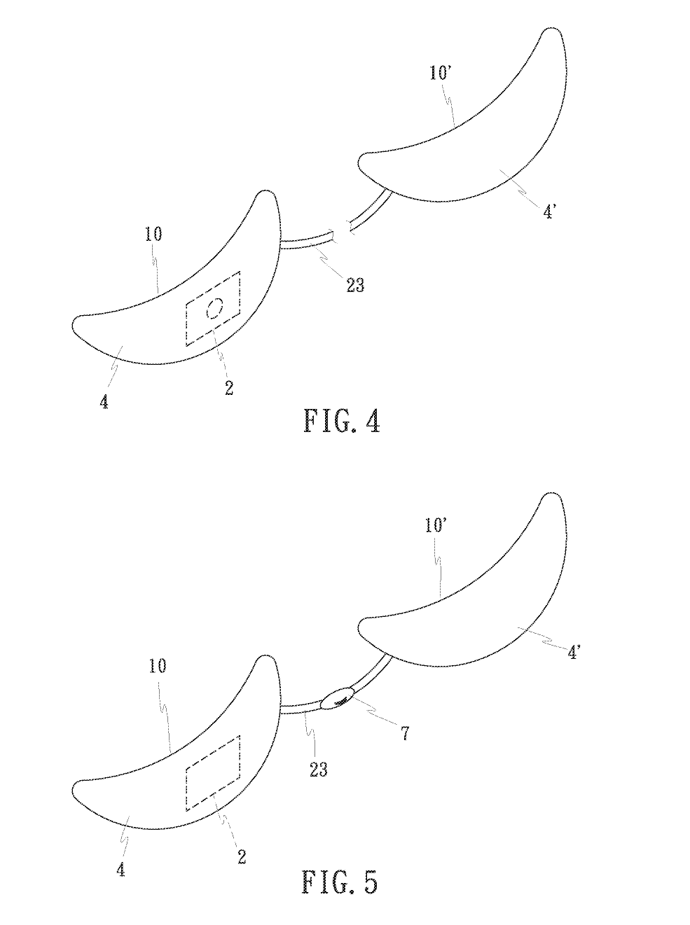

As shown in FIG. 1, one lead wire 22 of the controller 2 is connected to the electrically conductive inner cover layer 3 of the micro-current massaging brassiere pad 10. The other lead wire 23 of the controller 2 is connected to the electrically conductive inner cover layer 3′ of a second micro-current massaging brassiere pad 10′. Thus, the electrically conductive inner cover layers 3 and 3′ of the micro-current massaging brassiere pads 10 and 10′ constitute a positive pole conduction zone and a negative pole conduction zone respectively. These two micro-current massaging brassiere pads 10 and 10′ are arranged into a set (see FIG. 4). This second micro-current massaging brassiere pad 10′ comprises a pad 1′, an inner cover layer 3′ and an outer cover layer 4′. However, this second micro-current massaging brassiere pad 10′ does not have any controller 2 installed in the pad 1′.

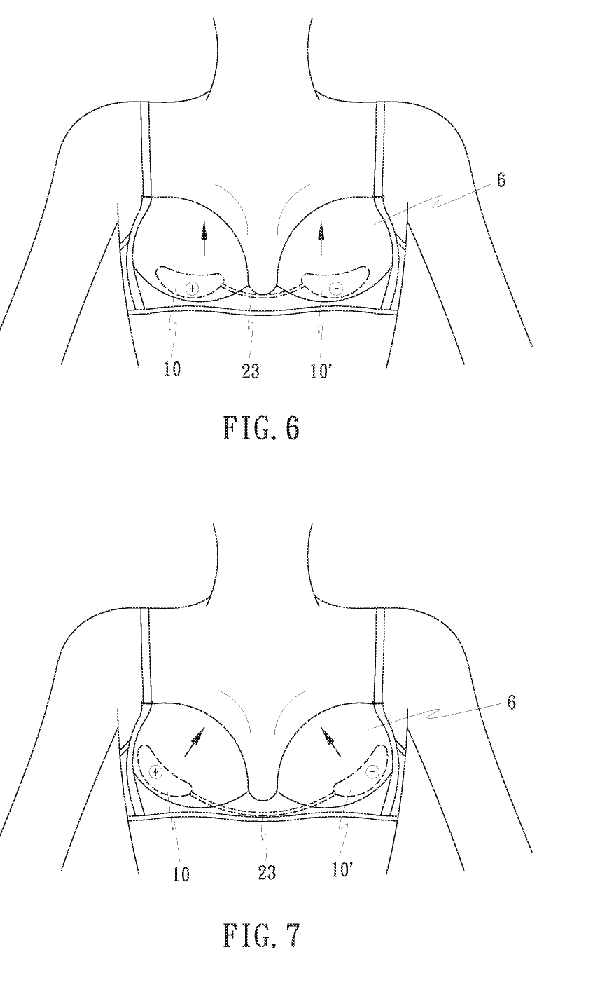

After the connection of the two lead wires 22 and 23 of the controller 2 to the electrically conductive inner cover layers 3 and 3′ of the micro-current massaging brassiere pads 10 and 10′, the micro-current massaging brassiere pads 10 and 10′ are respectively installed in a brassiere 6 (see FIG. 6 or FIG. 7). When electrically connected, a medium or low frequency current pulse is discharged through the electrically conductive inner cover layers 3 and 3′ of the micro-current massaging brassiere pads 10 and 10′ to massage the skin of the user's breasts 5, thereby stimulating blood circulation.

Referring to FIG. 5, the two lead wires 22 and 23 can be connected to a switch 7. A user can operate the switch 7 to turn on/off the controller 2 or to give another operation instruction.

Referring to FIG. 6, the micro-current massaging brassiere pads 10 and 10′ can be mounted in a brassiere 6 at the lower side of each of the two cups of the brassiere 6 to push up the user's breasts 5.

Referring to FIG. 7, the micro-current massaging brassiere pads 10 and 10′ can be mounted in a brassiere 6 around the outer bottom corner of each of the two cups of the brassiere 6 to push the breasts 5 upwardly inwards.

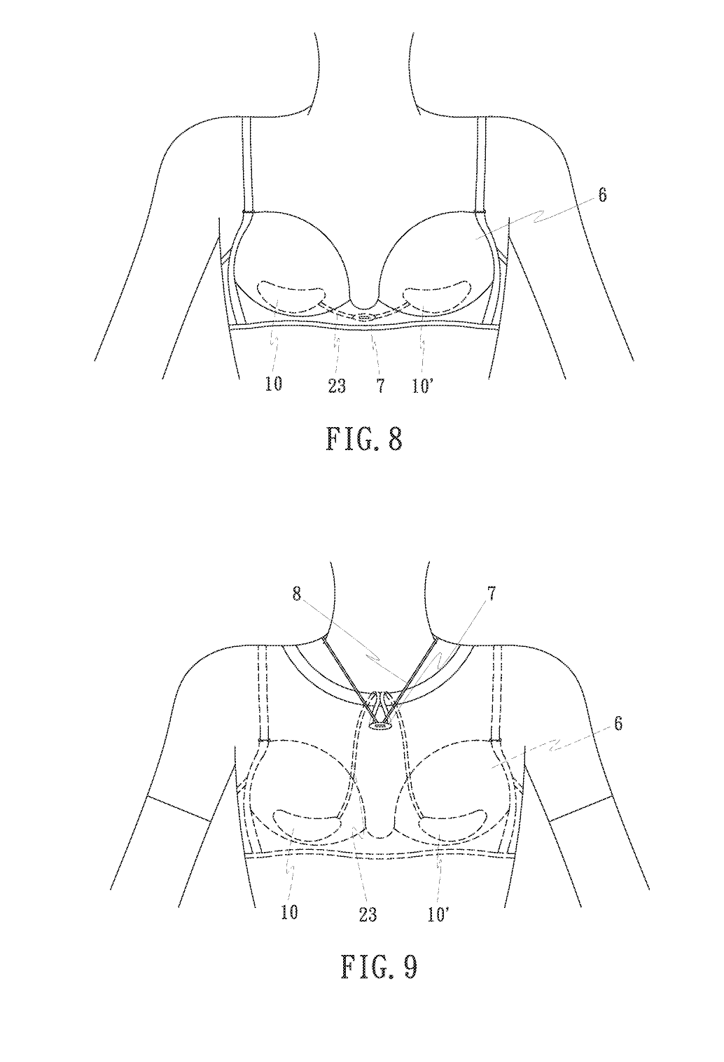

FIG. 8 illustrates the micro-current massaging brassiere pads 10 and 10′ mounted in a brassiere 6 worn on a woman, and a switch 7 connected between the two lead wires 22 and 23 of the controller and set in the midriff band of the brassiere 6.

FIG. 9 illustrates the micro-current massaging brassiere pads 10 and 10′ mounted in a brassiere 6 worn on a woman, and the switch 7 connected between the two lead wires 22 and 23 of the controller and set in a necklace 8 around the user's neck.

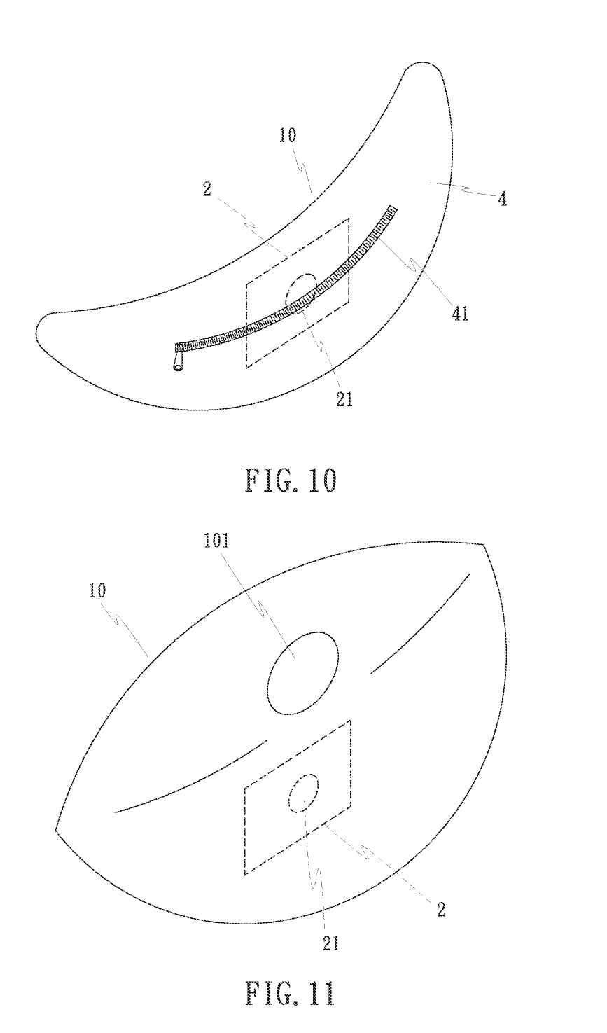

Referring to FIG. 10, the outer cover layer 4 of the micro-current massaging brassiere pad 10 can be made to have a resealable opening 41 (for example, a zip fastener-controlled opening). When the resealable 41 is opened, the user can load or unload the controller 2 conveniently.

Further, the micro-current massaging brassiere pad 10 can be made in any desired shape and size. Further, the micro-current massaging brassiere pad 10 can be made to have a through hole 101 (see FIG. 11) for the respective nipple to pass through, so as to prevent the medium or low frequency pulse from stimulating the nipple directly.

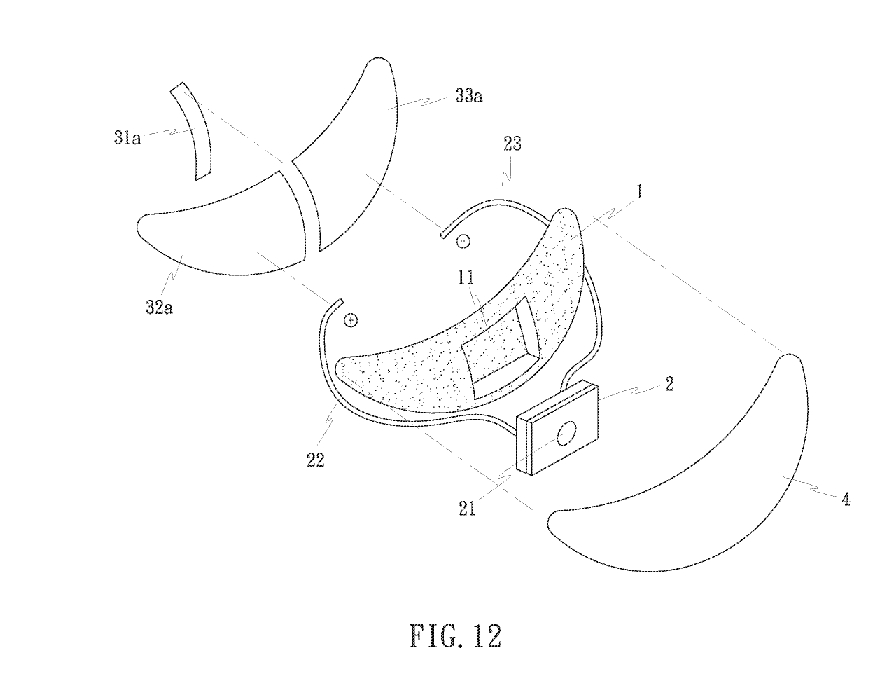

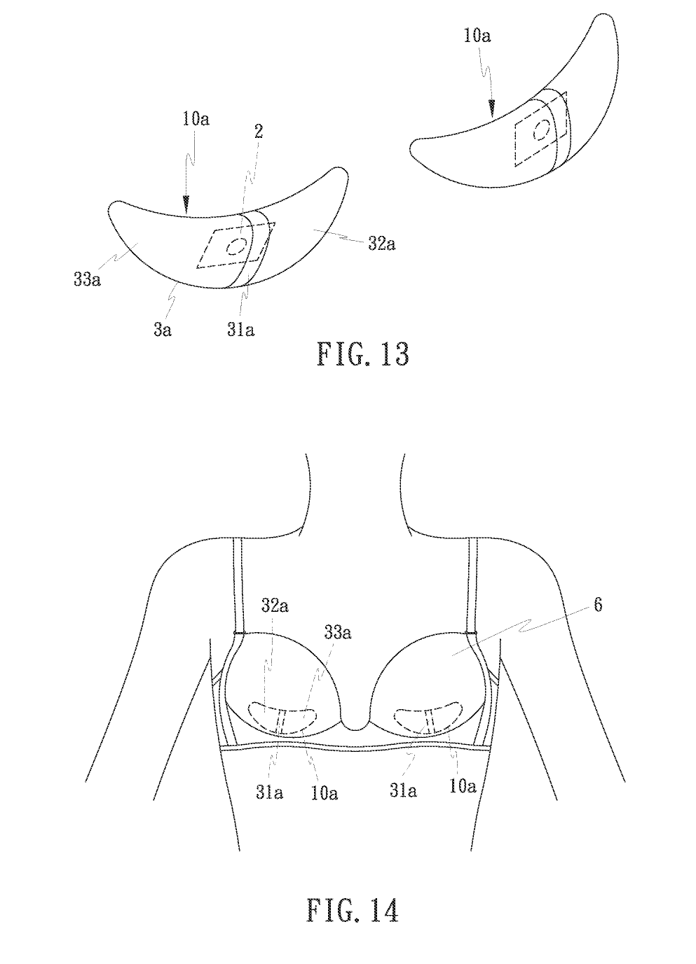

FIGS. 12˜14 illustrate an alternate form of the micro-current massaging brassiere pad 10a. This alternate form is substantially similar to that shown in FIG. 1 with the exception of the inner cover layer 3a. According to this alternate form, the inner cover layer 3a comprises two conducting zones 32a and 33a, and an insulative portion 31a set between the two conducting zones 32a and 33a to electrically insulate the conducting zones 32a and 33a from each other. Further, the two lead wires 22 and 23 of the controller 2 are respectively connected to the two conducting zones 32a and 33a. During application, two identical micro-current massaging brassiere pads 10a are respectively mounted in the two cups of a brassiere 6 (see FIG. 14).

Based on the spirit of the present invention, the controller 2 can be operated by means of a wireless control mode, i.e., a wireless remove control device can be used to control on/off of the controller 2 and to select the operation mode, etc.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A micro-current massaging brassiere pad, comprising:
a pad made of a flexible material, said pad having a recessed hole;
a controller mounted in said recessed hole of said pad, said controller comprising a control IC adapted to output a pulse waveform, the pulse width of said pulse waveform being programmably controllable, and two lead wires respectively extending out of said control IC for connection to a positive pole and a negative pole of a power source respectively;
an inner cover layer made of an electrically conductive material and covered on an inner side of said pad for direct contact with the skin of a breast of a female user, said inner cover layer being electrically connected to at least one of the lead wires of said controller; and
an outer cover layer made of an electrically insulative material and covered on an outer side of said pad;
wherein when electricity is connected through said lead wires of said controller, a medium or low frequency pulse is discharged through said inner cover layer to stimulate the breast of the female user.

2. The micro-current massaging brassiere pad as claimed in claim 1, wherein said controller has the two lead wires thereof respectively electrically connected to the inner cover layer of the micro-current massaging brassiere pad and an electrically conductive inner cover layer of a second micro-current massaging brassiere pad.

3. The micro-current massaging brassiere pad as claimed in claim 1, further comprising a switch connected to said lead wires for controlling operation of said controller.

4. The micro-current massaging brassiere pad as claimed in claim 1, wherein said outer cover layer has a resealable opening.

5. The micro-current massaging brassiere pad as claimed in claim 1, wherein said inner cover layer comprises a first conducting zone and a second conducting zone respectively electrically connected to the two lead wires of said controller, and an electrically insulative portion is set between said first conducting zone and said second conducting zone to electrically insulate said first conducting zone and said second conducting zone from each other.
